(19) United States
(12) Patent Application Publication
(10) Pub. No.: US 2002/0159264 A1
(43) Pub. Date: Oct. 31, 2002

(54) Assembling buckle structure for knockdown lamp shade

(76) Inventor: Mei-Ju Juang, Shulin City (TW)

Correspondence Address: BACON & THOMAS, PLLC, 625 Slaters Lane, 4th Floor, Alexandria, VA, 22314-1176, US

(21) Appl. No.: 09/842,856

(22) Filed: Apr. 27, 2001

(51) Int. Cl. F21V 1/06

(52) U.S. Cl. 362/352; 362/358; 362/360

(57) ABSTRACT

Assembling buckle structure for knockdown lamp shade, including assembling buckles, shade bodies and a tray body. The assembling buckles include upper buckles and lower buckles for connecting upper and lower sides of two shade body. Each assembling buckle having a main body formed with two symmetrical arched hook sections. The main body of the upper buckle is further formed with a C-shaped socket on rear side. The assembling buckles connect the shade bodies with each other. The tray body has multiple links inserted in the sockets of the assembling buckles to reinforce the entire structure and form a hollow lamp shade for receiving a bulb seat therein. The assemblies buckles are detachably assembled with the shade bodies, whereby the volume of the lamp shade can be minimized without affecting the rigidity thereof and the transferring and storage of the lamp shades can be facilitated.

### BACKGROUND OF THE INVENTION

The present invention is related to an assembling buckle structure for knockdown lamp shade which can be DIY replaceably assembled by a user. The respective components of the lamp shade can be separated from each other to facilitate transferring and storage and reduce cost.

A conventional lamp shade has a frame body on which a cover is laid for preventing the light from diverging so as to concentrate the light. For having sufficient strength and ensuring safety, such frame body is generally made of metal rods which are cut and then connected by welding. The fabric-made or paper-made cover is then laid on outer side of the frame body to form the lamp shade

According to the above arrangement, the metal rods are fixedly connected with each other by welding and cannot be disassembled after assembled. Therefore, such lamp shade has a considerably large volume which makes it difficult to store or transfer a number of lamp shades, especially after the lamp shades are stacked. This leads to increased cost for transferring.

### SUMMARY OF THE INVENTION

It is therefore a primary object of the present invention to provide an assembling buckle structure for knockdown lamp shade in which the support rods are all detachably assembled with the shade bodies without affecting the rigidity of the lamp shade. Therefore, the volume of the lamp shade can be minimized to facilitate the transferring and storage.

The present invention can be best understood through the following description and accompanying drawings wherein:

### BRIEF DESCRIPTION OF THE DRAWINGS

FIG. 1 is a perspective exploded view of the present invention;

FIG. 2 is a perspective exploded view of a part of the present invention;

FIG. 3 is a sectional view of a part of the present invention;

FIG. 4 is a perspective assembled view of the present invention; and

FIG. 5 shows that the respective components of the present invention are separated from each other to minimize the volume.

### DETAILED DESCRIPTION OF THE PREFERRED EMBODIMENT

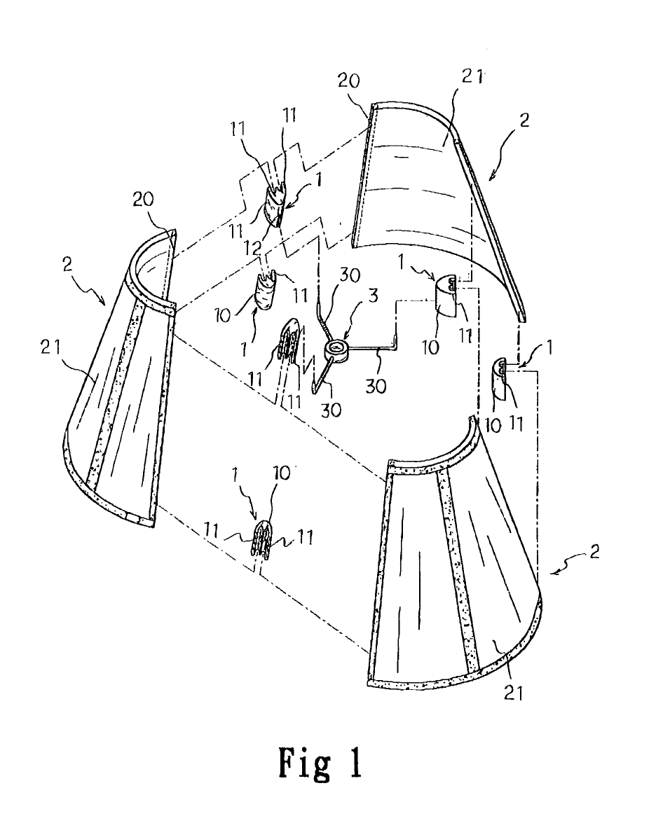

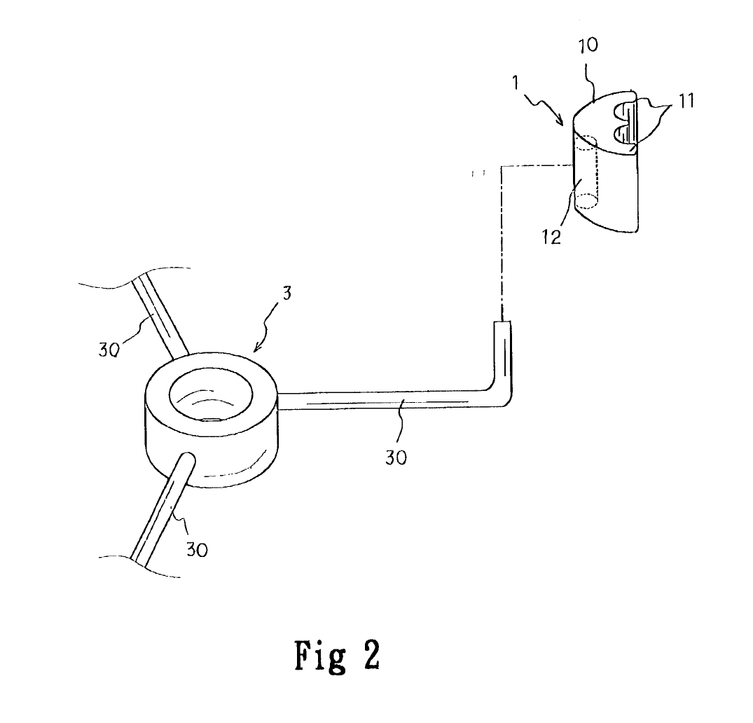

Please refer to FIGS. 1 and 2. The lamp shade of the present invention includes assembling buckles 1, shade bodies 2 and a tray body 3.

The assembling buckles 1 include upper buckles and lower buckles. Each assembling buckle 1 has a main body 10 having two symmetrical arched hook sections 11. The main body of the upper buckle is further formed with a C-shaped socket 12 on rear side. The assembling buckle 1 is made of soft plastic or rubber material for more tightly and firmly attaching to the shade body 2.

The shade body 2 is made of metal rods 20 and cooperative fabric or paper-made cover 21 and serves to prevent the light from diverging so as to concentrate the light.

The tray body 3 has three bent links 30 projecting from the periphery thereof and containing three angles. The links 30 are connected with the assembling buckles 1 and the shade bodies 2 to form a firm and stable frame.

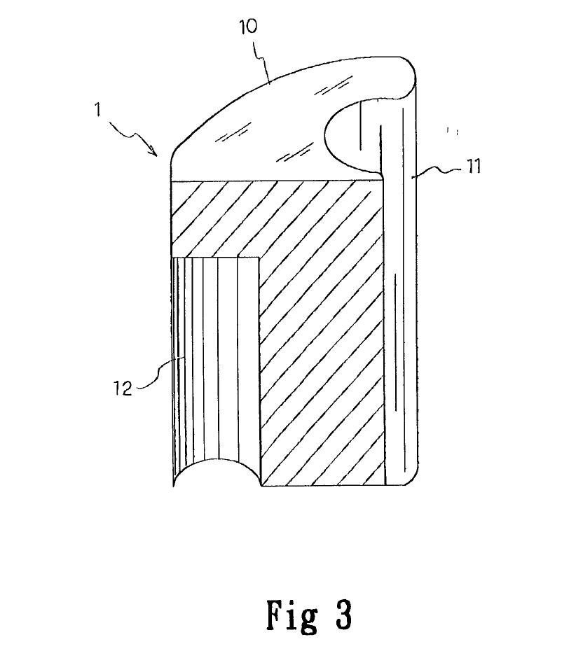

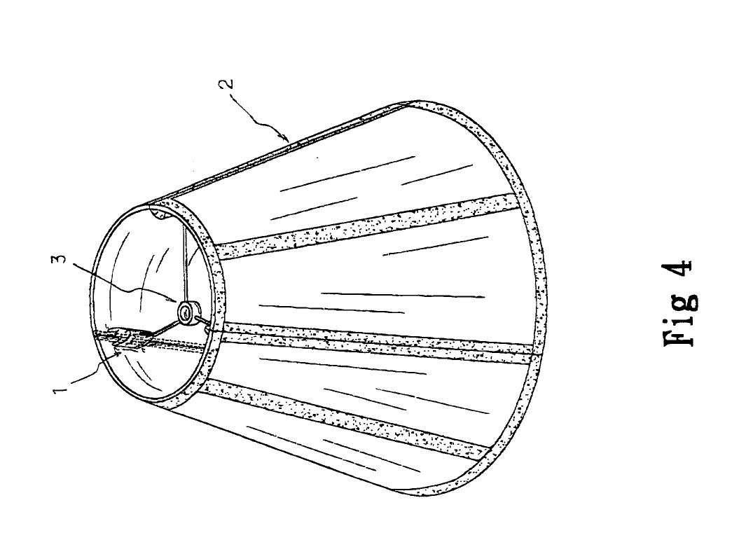

When assembled, the shade bodies 2 are first assembled with the assembling buckles 1. The adjacent lateral edges of two shade bodies 2 are fixedly inserted into the hook sections 11 of the main body 10 of the assembling buckle 1 one by one as shown in FIG. 4. All the shade bodies 2 are assembled to form a complete hollow lamp shade pattern. Then, the tray body 3 is fixedly connected on the upper opening of the shade body 2. The links 30 of the tray body 3 are fixedly inserted into the C-shaped sockets 12 of rear sides of the main bodies 10 to make the entire lamp shade structure more rigid without deformation as shown in FIG. 3.

The lamp shade can be DIY replaceably assembled by a user.

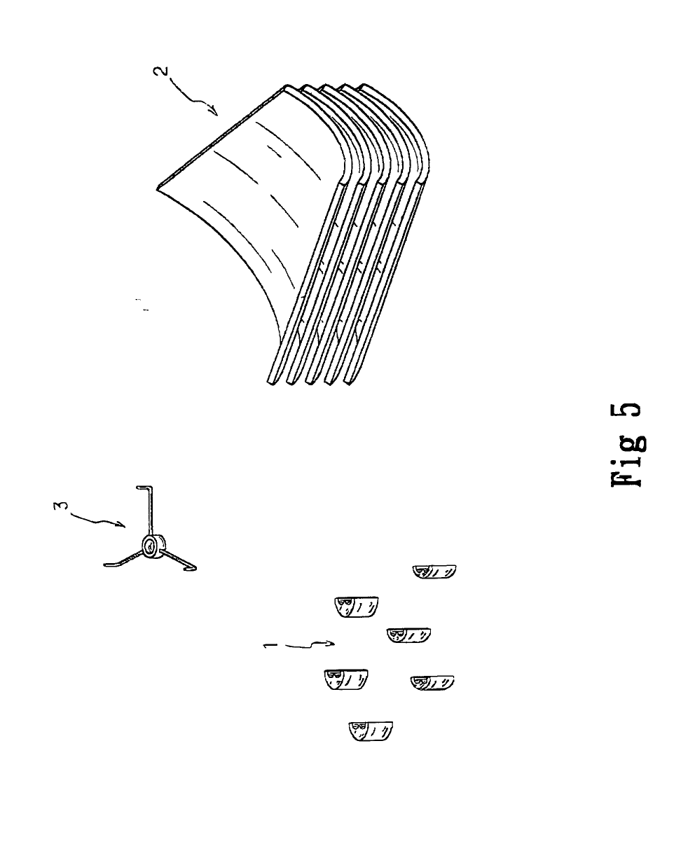

Referring to FIG. 5, prior to assembly, the assembling buckles 1 and shade bodies 2 are separate bodies so that they can be collectively stored to minimize the volume of the lamp shade. In the case of mass-production, the respective components are collected and stored so as to facilitate transferring.

The above embodiment is only used to illustrate the present invention, not intended to limit the scope thereof. Many modifications of the above embodiment can be made without departing from the spirit of the present invention.

What is claimed is:

1. Assembling buckle structure for knockdown lamp shade, comprising assembling buckles, shade bodies and a tray body, the assembling buckles including upper buckles and lower buckles for connecting upper and lower sides of two shade body, the shade body being made of metal rods and cooperative fabric or paper-made cover, the tray body having bent links projecting from the periphery thereof, said assembling buckle structure being characterized in that each assembling buckle having a main body formed with two symmetrical arched hook sections, the main body of the upper buckle being further formed with a C-shaped socket on rear side.
